(19) United States
(12) Patent Application Publication
(10) Pub. No.: US 2014/0036648 A1
(43) Pub. Date: Feb. 6, 2014

(54) OPTICAL DISC DEVICE

(71) Applicant: Hitachi Media Electronics Co., Ltd., Oshu-shi (JP)

(72) Inventors: Mitsuru NAGASAWA, Tokyo (JP); Kazuyoshi YAMAZAKI, Tokyo (JP); Shinsuke ONOE, Tokyo (JP)

(73) Assignee: HITACHI MEDIA ELECTRONICS CO., LTD., Oshu-shi (JP)

(21) Appl. No.: 13/958,065

(22) Filed: Aug. 2, 2013

(30) Foreign Application Priority Data
Aug. 2, 2012 (JP) 2012-172131

(51) Int. Cl. G11B 7/1392

(52) U.S. Cl. CPC G11B 7/1392
USPC 369/44.23

(57) ABSTRACT

Disclosed is an optical disc device that provides a stable servo signal with a simple configuration during the use of an objective lens showing significant color aberration. At time T0, which is before the start of a write operation (time T2), a defocus application circuit 111 generates a defocus signal DF1 to be added to a focusing error signal FES. A tracking signal gain control circuit 113 changes a tracking signal gain correction amount to be given to a tracking error signal TES to TG1. The defocus signal generated from the defocus application circuit terminates at substantially the same time the write operation starts (time T2). After the focusing error signal FES is no longer offset (at time T3), the tracking signal gain correction amount generated from the tracking signal gain control circuit 113 is restored to a reference value.

### CLAIM OF PRIORITY

The present application claims priority from Japanese Patent Application Serial No. JP 2012-172131, filed on Aug. 2, 2012, the content of which is hereby incorporated by reference into this application.

### BACKGROUND OF THE INVENTION

(1) Field of the Invention

The present invention relates to an optical disc device that provides stabilized servo control and performs a read or write operation from or to an optical disc.

(2) Description of the Related Art

If the oscillation wavelength of a semiconductor laser changes to cause color aberration when the read or write operation from or to the optical disc is performed, a focusing servo becomes unstable.

To address the above problem, an optical pickup device described in JP-A-2004-199768, which uses a blue-violet semiconductor laser and an objective lens made of high refractive index glass, is designed to not only reduce the amount of defocus even in the event of an instantaneous wavelength change that cannot be followed by focusing, but also correct spherical aberration caused by an oscillation wavelength change in a light source that is caused by a temperature change. More specifically, a diffraction section of an expander lens EXP generates diffracted light having a predetermined diffraction order in accordance with the wavelength of a light beam emitted from a light source LD. This diffraction effect is used to provide wavelength dependence so that paraxial power increases with an increase in the wavelength of the light source LD and decreases with a decrease in the wavelength of the light source. Further, the amount of paraxial power change in the diffraction section with respect to the wavelength change is made appropriate for the color aberration of the objective lens OBJ. This makes it possible to reduce the amount of defocus in the event of a mode hop of the light source LD.

An optical pickup for an optical recording device described in JP-T-2009-540485 is designed to correct color aberration caused by mode switching from a read mode to a write mode by controlling an objective lens in such a manner as to eliminate the influence of a defocus offset resulting from color aberration caused by a laser diode wavelength change that occurs at an instant at which a changeover is made from the read mode to the write mode. More specifically, the color aberration caused by mode switching from the read mode to the write mode is corrected in two steps. In the first step, which is performed before mode switching from the read mode to the write mode, a focus offset is applied to the objective lens in such a manner as to reduce the amount of defocus caused by color aberration resulting from a wavelength change occurring when the output optical power of a light source changes from read optical power to write optical power. In the second step, the defocus is corrected by switching to the write mode and allowing the light source to output the read optical power while the focus offset is applied to the objective lens.

### SUMMARY OF THE INVENTION

Media having different recording capacities and being compliant with different standards, such as CDs, DVDs, and BDs (Blu-ray Discs), are available as currently commercialized optical discs. When information is to be written to or read from an optical disc, an optical pickup device mounted in an optical disc device operates so that a light beam emitted from a semiconductor laser is focused on an information layer of the optical disc with an objective lens to write the information or operates so that the light-receiving surface of a photodetector detects a light beam reflected from the information layer to read the information written on the optical disc. In such an instance, servo signals are generated from a signal detected by the photodetector. Examples of the servo signals include an RF (Radio Frequency) signal that serves as an information read signal, a focusing error signal (FES) that serves as a control signal for focusing in a direction perpendicular to an optical disc surface, and a tracking error signal (TES) that serves as a control signal for following tracks in an optical disc plane.

When writing information to an optical disc, the optical disc device increases the light emission power of the semiconductor laser to form a write mark in the information layer of the optical disc. When the light emission power of the semiconductor laser is increased, the wavelength of a light beam emitted from the semiconductor laser shifts toward a long wavelength side. When such a wavelength shift occurs, optical components of the optical pickup device suffer from a focus position change, that is, color aberration. Particularly, the objective lens suffers from serious color aberration because it has a short focal distance and a small curvature radius. Therefore, at an instant at which the optical disc device switches from the read mode to the write mode, the light beam suffers from color aberration due to a wavelength change. As a result, defocus occurs. More specifically, the focus position of the light beam, which is focused on the information layer of the optical disc, becomes offset in the direction of focusing to deviate from accurate focus. If defocus occurs during a write, the servo may become unstable, resulting in the failure to perform a normal write operation.

According to JP-A-2004-199768, the optical pickup device uses an optical component (expander lens) for correcting the color aberration. However, an increase in the number of optical components not only decreases light transmittance, but also complicates an optical system, thereby causing a cost increase.

According to JP-T-2009-540485, the color aberration occurring at the time of switching to the write mode is corrected by giving a focus offset to the objective lens before switching to the write mode. However, if a large amount of focus offset is given, a defocus state prevails before switching to the write mode. As a result, the amplitude of the tracking error signal (TES) deteriorates to destabilize a tracking servo.

The severity of the above-described problems increases during the use of a lens compatible with a plurality of wavelengths. If the employed configuration uses one objective lens for optical discs compliant with different standards, such as DVDs and BDs, in order to commonalize the optical system, the objective lens needs to be shaped to provide compatibility with different wavelengths. This increases the amount of color aberration on various types of optical discs, thereby increasing the amount of defocus prevailing at the beginning of a write operation.

The present invention has been made in view of the above circumstances. An object of the present invention is to provide an optical disc device that exercises stable servo control without using an additional optical component for color aberration correction when an objective lens showing significant color aberration is used.

In accomplishing the above object, according to one aspect of the present invention, there is provided an optical disc device that has an optical pickup device and reads information from or writes information to an optical disc. The optical pickup device includes at least a laser light source for emitting a light beam, an objective lens for focusing the light beam on an information layer of the optical disc, and a photodetector having a plurality of light-receiving surfaces for receiving the light beam reflected from the information layer of the optical disc. The optical disc device includes at least a servo signal generation circuit, a focus control circuit, a tracking control circuit, a defocus application circuit, a tracking signal gain control circuit, and a control circuit for controlling the above circuits. The servo signal generation circuit generates a focusing error signal and a tracking error signal by using a signal detected by the photodetector. The focus control circuit exercises control to place the objective lens at a position in a focus direction with respect to the optical disc in accordance with the focusing error signal. The tracking control circuit exercises control to place the objective lens at a desired track position with respect to the optical disc in accordance with the tracking error signal. The defocus application circuit generates a defocus signal to be added to the focusing error signal. The tracking signal gain control circuit generates a tracking signal gain correction amount to be given to the tracking error signal. Before changing the light beam from a light intensity of 1 to a different light intensity of 2, the control circuit causes the defocus application circuit to generate a predetermined defocus signal and changes the tracking signal gain correction amount to be generated from the tracking signal gain control circuit.

According to the present invention, it is possible to provide an optical disc device that exercises stable servo control without using an additional optical component for color aberration correction when an objective lens showing significant color aberration is used.

### BRIEF DESCRIPTION OF THE DRAWINGS

FIG. 1 is a configuration diagram illustrating an optical system of an optical pickup device mounted in an optical disc device according to a first embodiment of the present invention.

FIGS. 2A and 2B show defocus characteristics of various signals detected by a photodetector.

FIG. 3 is a block diagram illustrating the configuration of the optical disc device in which the optical pickup device shown in FIG. 1 is mounted.

FIG. 4 is a diagram illustrating signal waveforms in the optical disc device that appear during a write operation.

FIG. 5 is a flowchart illustrating a write operation.

FIG. 6 is a diagram illustrating signal waveforms in the optical disc device that appear during a write operation according to a second embodiment of the present invention.

FIG. 7 is a block diagram illustrating the configuration of the optical disc device according to a third embodiment of the present invention.

FIG. 8 is a diagram illustrating signal waveforms in the optical disc device that appear during a write operation according to the third embodiment.

FIG. 9 is a flowchart illustrating the write operation according to the third embodiment.

### DETAILED DESCRIPTION OF THE EMBODIMENTS

Embodiments of an optical disc device to which the present invention is applied will now be described with reference to the accompanying drawings. In the drawings, elements having the same functions are designated by the same reference numerals.

### First Embodiment

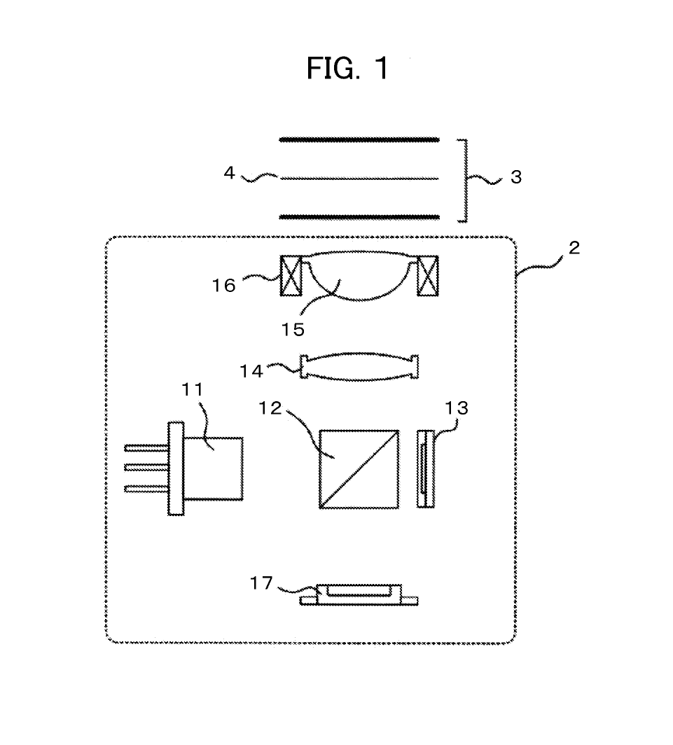

FIG. 1 is a configuration diagram illustrating an optical system of an optical pickup device 2 mounted in an optical disc device according to a first embodiment of the present invention. A laser light source 11 emits a light beam having a predetermined wavelength as divergent light. In general, the optical pickup device 2 uses a semiconductor laser as the laser light source 11. The light beam emitted from the laser light source 11 reflects from a beam splitter 12. The beam splitter 12 is an optical branching element that controls polarized light in such a manner as to transmit a linearly-polarized light oriented in a predetermined direction and reflect linearly-polarized light oriented in a direction orthogonal to the predetermined direction. Although FIG. 1 shows a prism as an example of the beam splitter 12, an optical branching element shaped, for instance, like a plane-polarization mirror may be used as the beam splitter 12.

A predetermined amount of light beam reflects from the beam splitter 12 and enters a collimator lens 14. The remaining light beam passes through the beam splitter 12 and enters a front monitor 13. To perform a stable read/write operation on an optical disc, it is generally necessary to ensure that a desired amount of light beam enters the optical disc. The front monitor 13 detects a change in the amount of light emitted from the laser light source 11 and feeds the detected change back to a control circuit to adjust the amount of light beam as desired. The collimator lens 14 changes an incident light beam to a substantially parallel light beam. The light beam transmitted through the collimator lens 14 is transmitted through an objective lens 15 mounted in an actuator 16 and focused on an information layer 4 of an optical disc 3.

The actuator 16 is at least configured to drive the objective lens 15 in a direction substantially perpendicular to the surface of the optical disc (hereinafter referred to as the focus direction) and in a direction that is substantially parallel to the optical disc surface and substantially orthogonal to tracks in the information layer (hereinafter referred to as the tracking direction). A tracking error signal (TES) is used to drive the objective lens 15 in the tracking direction (tracking control). A focusing error signal (FES) is used to drive the objective lens 15 in the focus direction (focus control). It is assumed that the objective lens 15 according to the present embodiment generates a significant amount of color aberration, namely, generates a color aberration of 0.4 μm or more in response to a wavelength change of 1 nm. The light beam reflected from the information layer 4 of the optical disc 3 is passed through the objective lens 15 and the collimator lens 14, transmitted through the beam splitter 12, and focused on a photodetector 17. The photodetector 17 includes a plurality of light-receiving surfaces which receives the light beam, and generates the focusing error signal (FES) and the tracking error signal (TES) which are servo signals, and an RF signal which is a read signal, in accordance with the amount of light incident on the light-receiving surfaces.

In the present embodiment, a method of detecting, for instance, the focusing error signal, the tracking error signal, and the read signal is not specifically limited. For example, an optical detection lens (not shown) is disposed between the beam splitter 12 and the photodetector 17, and the photodetector 17 has four squarely arranged segmented light-receiving surfaces. The light beam is incident on the four segmented light-receiving surfaces to detect the focusing error signal (FES) by determining the differential between the sums of signals of diagonal light-receiving segment surfaces, detect the tracking error signal (TES) by determining the differential between push-pull component signals, and detect the read signal (RF) by determining the sum of signals of the four segmented light-receiving surfaces. As an alternative configuration, a light diffraction element may be disposed between the laser light source 11 and the beam splitter 12. As another alternative configuration, a light diffraction element may be disposed between the beam splitter 12 and the photodetector 17. Obviously, the light-receiving surfaces of the photodetector 17 are not limited to four squarely arranged segmented light-receiving surfaces.

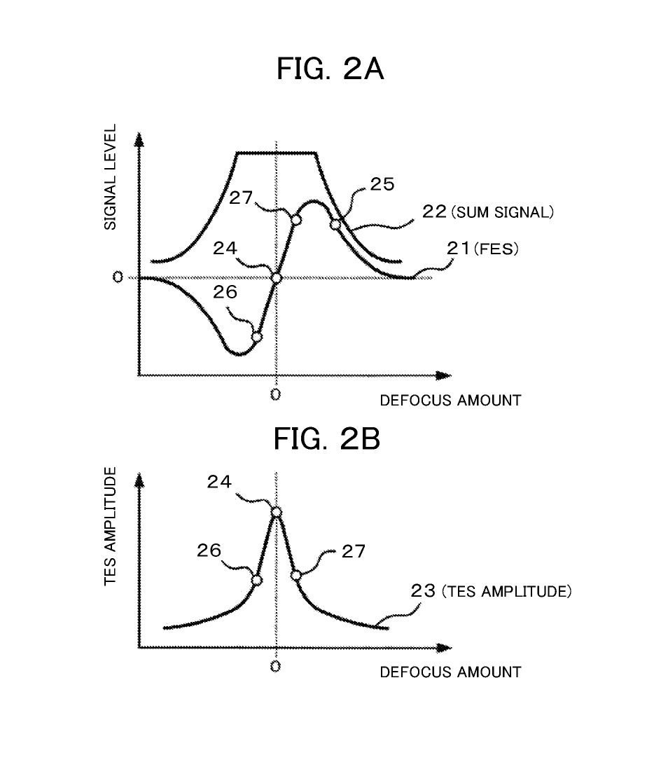

FIGS. 2A and 2B show defocus characteristics of various signals detected by the photodetector 17. More specifically, these figures illustrate changes in the various signals that occur when the objective lens 15 is displaced (defocused) in the focus direction which is substantially perpendicular to the optical disc surface. FIG. 2A shows changes in the focusing error signal (FES) 21 and the sum signal 22 that represents the sum of a received signal. FIG. 2B shows changes in the amplitude 23 of the tracking error signal (TES). The horizontal axis indicates the defocus amount of the objective lens 15. A defocus amount of 0 represents a just-focus state in which the light beam is precisely focused on the information layer 4 of the optical disc 3. If the defocus amount is a minus value (in a left region in the figures), it means that the focus position of the objective lens 15 is displaced forward from the information layer 4. If, on the other hand, the defocus amount is a plus value (in a right region in the figures), it means that the focus position of the objective lens 15 is displaced rearward from the information layer 4.

As shown in FIG. 2A, the focusing error signal (FES) 21 is generally curved like the letter S. When defocus occurs, the focusing error signal (FES) is generated in such a manner that the polarity of the focusing error signal (FES) is either plus or minus depending on the direction of the defocus. As shown in FIG. 2B, the amplitude of the tracking error signal (TES) 23 is maximized in the just-focus state (defocus=0) as indicated at 24 and reduced in the event of defocus.

A status change occurring when an operating mode is changed from a read mode to a write mode will now be described. In the read mode, focus control is exercised to maintain a just-focus position 24. When a write operation starts in such a state, the wavelength shifts toward a long wavelength side because the light emission power of the laser light source 11 increases. If, for instance, the light emission power of the laser light source 11 increases to cause a wavelength shift of ±5 nm, the amount of color aberration is as large as ±2 μm in assuming that the color aberration characteristics of the objective lens 15 according to the present embodiment generate a color aberration of 0.4 μm or more in response to a wavelength change of 1 nm. As a result, the focus position is displaced rearward from the information layer 4 due to the color aberration caused by the objective lens 15. This displaces the focus position in a plus defocus direction. If, in such an instance, the amount of color aberration is small so that the focus position is displaced to a region in front of a peak of the S curve (e.g., displaced to a position indicated at 27), a focus pull-in operation can be performed to restore the just-focus position 24. However, if the amount of color aberration is large so that the focus position is displaced to a region beyond the peak of the S curve (e.g., displaced to a position indicated at 25), normal focus control cannot be provided because the focus pull-in operation fails. It should be noted that the amount of color aberration is determined in accordance with the relationship to a peak of the S curve. If the allowable range between the peaks of the S curve of the focusing error signal is small, unstable focus control results even if the amount of color aberration is small.

The above problem can be avoided by driving the objective lens 15 in a minus defocus direction immediately before the start of a write operation, as described in JP-T-2009-540485. When the focus position is offset in a minus direction in advance, the focus pull-in operation can be performed even if color aberration occurs at the beginning of the write operation to incur displacement in the plus defocus direction. For example, the focus position can be displaced to a position indicated at 26 immediately before the start of a write operation for adjustment purposes so that the focus position is displaced to a position in front of the peak of the S curve, such as a position indicated at 27, even if color aberration occurs after the start of the write operation to displace the focus position. This ensures that focus control is properly exercised to restore the just-focus position 24.

However, the use of the above method results in the deterioration of the tracking error signal. As shown in FIG. 2B, the amplitude 23 of the tracking error signal (TES) generally deteriorates when a defocus amount is given. The amplitude of the tracking error signal is maximized at a position indicated at 24 at which the light beam is precisely focused on the information layer 4 of the optical disc 3. However, if a light spot on the information layer 4 is blurred due to defocus, the amplitude is reduced. The diameter of the light spot on the information layer 4 of the optical disc 3 significantly changes particularly during the use of a BD or other optical disc having a large numerical aperture NA and a small wavelength A. In other words, even when the defocus amount is small, the light spot diameter increases, resulting in the failure to obtain a desired tracking error signal amplitude.

Referring, for instance, to FIG. 2B, if a defocus amount is given to exercise focus control so as to place the focus position at a position indicated at 26 immediately before a write operation and place the focus position at a position indicated at 27 immediately after the write operation, the amplitude 23 of the tracking error signal (TES) attenuates. If the amplitude 23 decreases below its allowable value (lower-limit value), normal tracking control cannot be provided. It is needless to say that unstable tracking control results in the failure to start the write operation at a desired track position. In general, the tracking error signal can be corrected by exercising automatic gain control (AGC) with the signal level of the sum signal 22. However, the sum signal 22 is generally flat between the peaks of the S curve as shown in FIG. 2A. Therefore, the correction provided by AGC between the peaks of the S curve does not take effect.

As described above, when color aberration is to be corrected, control needs to be provided to exercise not only stable focus control but also stable tracking control. To implement such control, the present embodiment applies a defocus amount to the focusing error signal a predetermined period of time before the start of a write operation and changes a gain correction amount for the tracking error signal. Control provided by the present embodiment is described below.

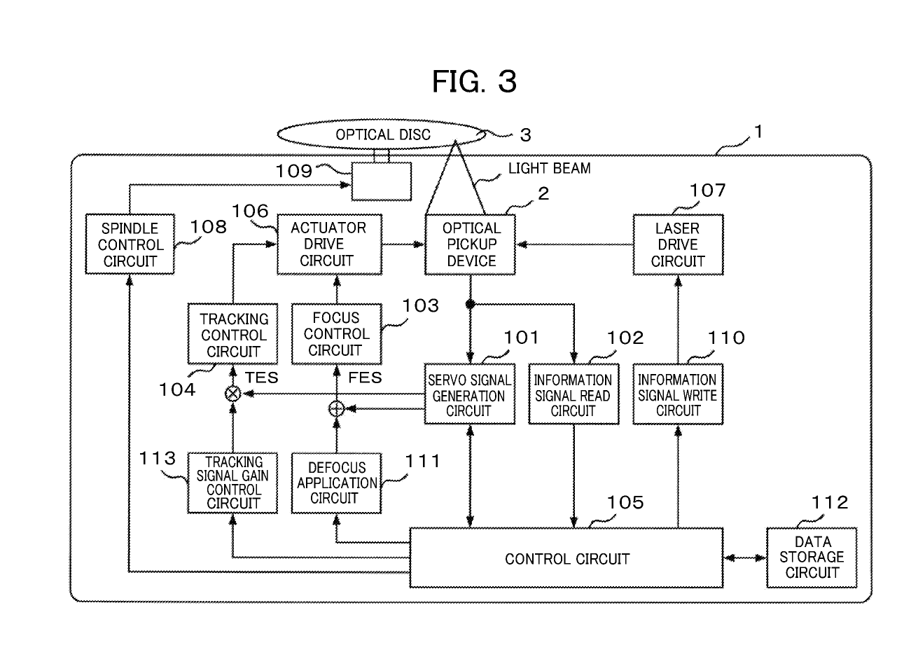

FIG. 3 is a block diagram illustrating the configuration of the optical disc device 1 in which the optical pickup device 2 shown in FIG. 1 is mounted. A servo system is configured so that a signal detected by the photodetector 17 of the optical pickup device 2 is delivered to a servo signal generation circuit 101. In accordance with the signal detected by the optical pickup device 2, the servo signal generation circuit 101 generates a focusing error signal (FES) and a tracking error signal (TES) as appropriate for the optical disc 3. The focusing error signal is input to a focus control circuit 103. The tracking error signal is input to a tracking control circuit 104. Part of these servo signals are delivered to a control circuit 105 as well and processed through a defocus application circuit 111 and a tracking signal gain control circuit 113 in order to provide stable control in response to the generation of color aberration. In accordance with control signals from the focus control circuit 103 and the tracking control circuit 104, an actuator drive circuit 106 drives the actuator 16 in the optical pickup device 2 to control the position of the objective lens 15.

The control circuit 105 transmits a laser drive signal to a laser drive circuit 107. The laser drive circuit 107 supplies an appropriate laser drive current to the laser light source 11 in the optical pickup device 2. The control circuit 105 is also connected to a spindle control circuit 108 to control the rotation of a spindle motor 109 that rotates the optical disc 3.

An information signal write circuit 110, which is disposed between the control circuit 105 and the laser drive circuit 107, is used to write to the optical disc 3. The information signal write circuit 110 generates a signal for forming a laser light emission waveform in accordance with write data input from the control circuit 105, and drives the laser drive circuit 107 to emit optimum laser light.

When the optical disc 3 is to be read, the signal detected by the optical pickup device 2 is input to an information signal read circuit 102 in order to read an information signal written on the optical disc 3. The information signal is delivered to the control circuit 105 and processed to acquire desired read information. The present embodiment is characterized in that it includes the defocus application circuit 111 and the tracking signal gain control circuit 113 in order to correct color aberration. These circuits are described below.

The defocus application circuit 111 adds a predetermined defocus signal (defocus amount) to the focusing error signal in order to correct color aberration generated due to a change in the light emission power of laser light. The light emission power dependence of the amount of color aberration generated by the objective lens 15 of the optical pickup device 2 and the defocus signal to be added are stored in advance in a data storage circuit 112. At the beginning of a write operation, the control circuit 105 accesses the data storage circuit 112, reads a defocus signal appropriate for correcting the amount of color aberration generated by the light emission power prevailing during the write operation, and inputs the defocus signal to the defocus application circuit 111. The defocus application circuit 111 adds (applies) the defocus signal to the focusing error signal generated by the servo signal generation circuit 101 and supplies the resulting signal to the focus control circuit 103. A timing at which the defocus signal is applied is controlled by the control circuit 105 so as to apply the defocus signal during a predetermined period. An optimum value of the defocus signal (defocus amount) to be applied may be determined by learning in real time the displacement amount of the focusing error signal that is generated by the light emission power.

The tracking signal gain control circuit 113 corrects a tracking signal gain, which is a gain relative to the tracking error signal, in accordance with the above color aberration correction. In other words, the tracking signal gain control circuit 113 maintains an appropriate amplitude in relation to the deterioration of the tracking error signal generated by the servo signal generation circuit 101 that is caused by the aforementioned defocus signal application. In the past, an optimum tracking signal gain was set for the tracking error signal during a period of the read mode and write mode of the optical disc 3. The present embodiment corrects the tracking signal gain only during a limited period before and after the start of a write operation.

A tracking error signal amplitude, which deteriorates due to defocus, and a tracking signal gain correction amount necessary for amplitude correction are stored in advance in the data storage circuit 112. At the beginning of a write operation, the control circuit 105 accesses the data storage circuit 112, reads the tracking signal gain correction amount appropriate for the defocus signal applied by the defocus application circuit 111, and inputs the tracking signal gain correction amount to the tracking signal gain control circuit 113. The tracking signal gain control circuit 113 multiplies the tracking error signal generated from the servo signal generation circuit 101 by the tracking signal gain correction amount, and supplies the multiplication result to the tracking control circuit 104. A timing at which the tracking signal gain is corrected is controlled by the control circuit 105 so as to correct the tracking signal gain during a predetermined period.

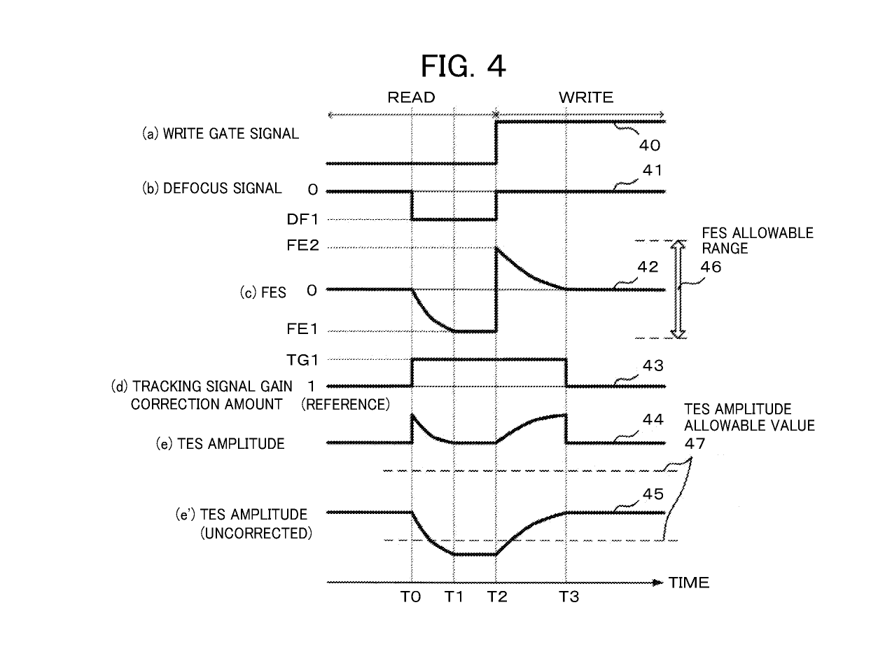

FIG. 4 is a diagram illustrating signal waveforms in the optical disc device that appear during a write operation. The horizontal axis is a time axis. Individual signal waveforms are described below. Signal waveform (a) represents a write gate signal 40 that indicates whether emitted laser light is in a write state or in a read state. FIG. 4 indicates that the emitted laser light switches from the read state to the write state at time T2. Signal waveform (b) represents a defocus signal 41 that is output from the defocus application circuit 111. The defocus signal 41 is added to the focusing error signal (FES) generated by the servo signal generation circuit 101. FIG. 4 indicates that a defocus amount DF1 is given during a period between time T0, which is before the start of a write operation, and time T2, which is the time for starting the write operation. Signal waveform (c) represents a focusing error signal (FES) 42 that is obtained when the defocus signal 41 represented by signal waveform (b) is added to the focusing error signal generated by the servo signal generation circuit 101.

Signal waveform (d) represents a tracking signal gain correction amount 43 that is output from the tracking signal gain control circuit 113. The tracking signal gain correction amount 43 is multiplied by the tracking error signal (TES) generated by the servo signal generation circuit 101. FIG. 4 indicates that a normal tracking signal gain correction amount is 1 (reference value), and that a tracking signal gain correction amount TG1 is given during a period between time T0, which is before the start of a write operation, and time T3, which is after the start of the write operation. Signal waveform (e) represents an amplitude 44 of the tracking error signal (TES) that is obtained when the amplitude of the tracking error signal generated by the servo signal generation circuit 101 is multiplied by the tracking signal gain correction amount 43 represented by signal waveform (d). Signal waveform (e′) serves as a comparative example (indicative of an uncorrected state) and represents an amplitude 45 of the tracking error signal (TES) that prevails when the tracking signal gain correction amount remains at 1 (reference value).

Referring to signal waveform (c), reference numeral 46 denotes an allowable range of the focusing error signal (FES) within which stable focus control is provided. Referring to signal waveforms (e) and (e′), reference numeral 47 denotes an allowable value (lower-limit value) of the amplitude of the tracking error signal (TES) at which stable tracking control is provided.

Operations performed in sequence by the present embodiment will now be described. In a read state before time T0, focus control is provided so that the focusing error signal (FES) 42 is 0 (zero). It means that the just-focus position is obtained. Further, the amplitudes 44, 45 of the tracking error signal (TES) are set at a predetermined value by giving a tracking signal gain correction amount that appears during the read state.

When a write operation is to be performed, that is, at time T0, which is immediately before the start of the write operation, the control circuit 105 accesses the data storage circuit 112, reads the defocus amount DF1 optimized for the amount of color aberration generated by the light emission power in the read state, and delivers the defocus amount DF1 to the defocus application circuit 111, as indicated by signal waveform (b). The defocus application circuit 111 adds the defocus amount DF1 to the focusing error signal received from the servo signal generation circuit 101 and delivers the addition result to the focus control circuit 103. As a result, the focusing error signal 42 obtained from the photodetector 17 gradually becomes displaced in accordance with the response characteristics of the actuator 16 due to the defocus amount DF1 added as the defocus signal 41, and reaches an offset amount FE1 at time T1, as indicated by signal waveform (c). In the above instance, the defocus amount DF1 to be given by the defocus signal 41 is set so that the offset amount FE1 does not exceed the allowable range 46 of the focusing error signal (FES).

At time T2, the write gate signal 40 switches from the read state to the write state so that the light emission power of the laser light source instantaneously increases to generate color aberration. Due to defocus caused by the generated color aberration, the offset amount of the focusing error signal 42 changes from FE1 to FE2 as indicated by signal waveform (c). The offset amount FE2 is also adjusted to prevent it from exceeding the FES allowable range 46. At time T2 at which the write gate signal 40 switches to the write state, the defocus amount of the defocus signal 41 returns from DF1 to 0 as indicated by signal waveform (b). As focus control is resumed, the focusing error signal 42 gradually becomes displaced in accordance with the response characteristics of the actuator 16 as indicated by signal waveform (c), and restores the just-focus position at time T3. It should be noted that the values of the offset amounts FE1, FE2 can be set as desired by the defocus signal DF1 given by the control circuit 105.

Meanwhile, the amplitude of the tracking error signal (TES) attenuates as indicated in FIG. 2B because the defocus amount DF1 indicated by signal waveform (b) is given at time T0 to generate a focus offset amount. In other words, the amplitude of the tracking error signal gradually attenuates in accordance with the displacement of the focusing error signal 42. If, for example, the tracking error signal amplitude 45 decreases below the TES amplitude allowable value 47 as indicated by signal waveform (e′) in FIG. 4, unstable tracking control results.

To address the above problem, the present embodiment changes the tracking signal gain correction amount. As indicated by signal waveform (d), a correction amount TG1 (>1) larger than the tracking signal gain correction amount (having the reference value of 1) set at the time of a read operation is given substantially at time T0 at which the defocus amount DF1 is applied. When the tracking signal gain correction amount increases, the tracking error signal amplitude 44 increases at time T0 as indicated by signal waveform (e). Even in a subsequent state where the focusing error signal 42 gradually becomes displaced to reach the offset amount FE1 at time T1, the tracking error signal amplitude 44 complies with the TES amplitude allowable value 47.

Even when the write gate signal 40 is placed in the write state at time T2, the tracking signal gain correction amount is continuously given a value of TG1. At time T2, the color aberration is defocused due to write power so that the focusing error signal 42 becomes displaced to FE2. However, as the defocus signal is returned from DF1 to 0 (zero), the displacement is gradually reduced due to a follow-up operation of the actuator 16. When the displacement of the focusing error signal 42 decreases, the tracking error signal amplitude 44 increases with time by the amount of increase in the tracking signal gain correction amount TG1.

When the focusing error signal 42 returns to the just-focus position at time T3, the tracking signal gain correction amount TG1 is reset to the previous tracking signal gain correction amount (the reference value of 1) for a write operation. This ensures that the tracking error signal amplitude 44 takes a normal value for a write operation. As regards the timing of time T3, the time interval (frequency response) between the write start time T2 and the follow-up operation of the actuator 16 is predetermined and stored in the data storage circuit 112. An alternative is to exercise control by learning in real time with the control circuit 105.

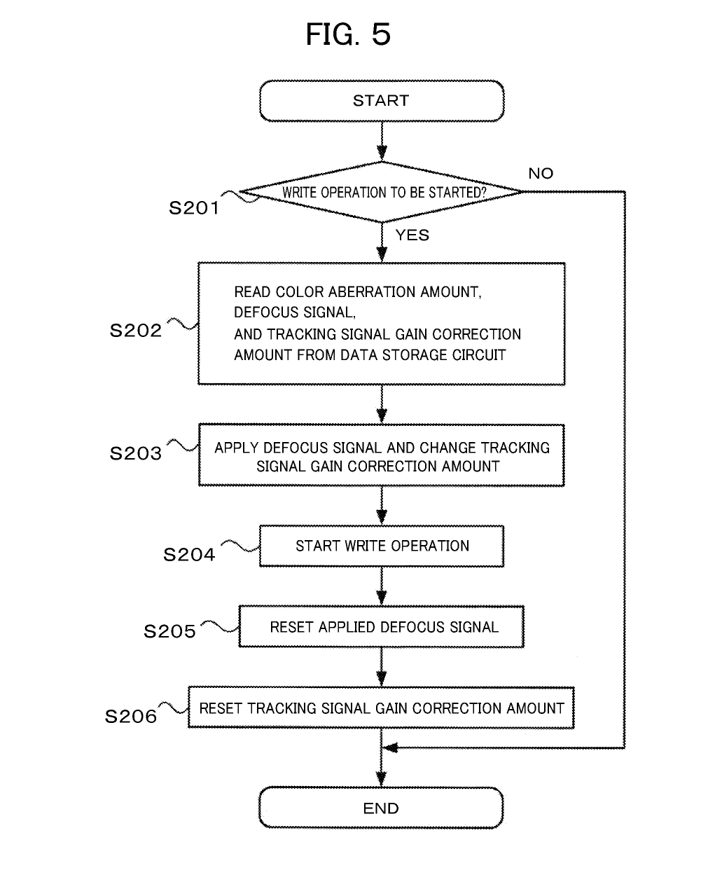

FIG. 5 is a flowchart illustrating a write operation. The following process is controlled by the control circuit 105. Individual steps will now be described in sequence. The process starts while a read operation is performed with the optical disc 3 inserted into the optical disc device 1.

Step S201 is performed to determine whether or not to start a write operation on the optical disc 3. If the query in step S201 is answered “YES”, processing proceeds to step S202. If, on the other hand, the query in step S201 is answered “NO”, the process terminates to continue with the read operation or stop the read operation. In step S202, the data storage circuit 112 is accessed to read the amount of color aberration generated by laser light emission power prevailing under current write conditions, a defocus signal (defocus amount) DF1 optimum for the amount of color aberration, and a tracking signal gain correction amount TG1 appropriate for the defocus signal (DF1).

Step S203 is performed at time T0, which is immediately before the start of the write operation, to apply (add) a predetermined defocus signal DF1 to the focusing error signal through the defocus application circuit 111. At the same time, the tracking signal gain correction amount is changed to TG1, and the tracking error signal is multiplied by the resulting tracking signal gain correction amount through the tracking signal gain control circuit 113. In step S204, after the objective lens 15 is displaced to a predetermined position FE1 in accordance with the applied defocus signal DF1, the write operation starts at time T2.

In step S205, the applied defocus signal DF1 is reset at the same time the laser light emission power is increased at the beginning of the write operation. In step S206, at time T3 at which stable focus control is provided as the actuator 16 performs a follow-up operation subsequently to the reset of the defocus signal, the tracking signal gain correction amount TG1 is reset to a normal value. In this instance, the time (T3 to T0) at which TG1 is applied as the tracking signal gain correction amount is read from the data storage circuit 112.

When control is exercised as described above, not only focus control but also tracking control can be provided in a stable manner in response to color aberration caused before and after the write operation.

In the above-described embodiment, the tracking signal gain correction amount remains at TG1 during an interval between time T0, which is immediately before the write operation, and time T2, which is the time for starting the write operation. However, an alternative is to use different tracking signal gain correction amounts, for example, use a tracking signal gain correction amount of TG1 at time T0 and a tracking signal gain correction amount of TG2 at time T2. When the tracking signal gain correction amounts used before and after the write operation are set independently, an optimum tracking signal gain correction amount can be used to correct not only the focus offset amount FE1 prevailing immediately before the write operation, but also the focus offset amount FE2 prevailing immediately after the write operation. As a result, an optimum tracking error signal amplitude can be obtained in each case.

To obtain a stable focusing error signal, it is preferred that the defocus signal DF1 given by the defocus application circuit 111 be equivalent to half the amount of color aberration caused by the write operation. If, for instance, the amount of color aberration is Δf, the value DF1 indicated by signal waveform (b) in FIG. 4 should be set to −Δf/2. In this instance, for the focusing error signal 42, the offset FE1 generated at time T2 is equivalent to −Δf/2, and the offset FE2 generated at time T2 is equivalent to Δf/2. When setup is performed as described above, the objective lens offset amount prevailing before and after the write operation can be minimized.

To obtain a stable tracking error signal amplitude, it is preferred that even when the tracking error signal amplitude is reduced by defocusing, the tracking signal gain correction amount TG1 be adjusted to obtain a tracking error signal amplitude of at least half its normal value.

The present embodiment has been described on the assumption that color aberration occurs when the laser light emission switches from the read state to the write state. However, color aberration also occurs when the laser light emission switches from the write state to the read state. Control provided by the present embodiment is widely applicable to a situation where a light beam emitted from a laser light source varies in light intensity.

As described above, the optical pickup device according to the first embodiment includes at least the laser light source for emitting a light beam, an objective lens for focusing the light beam on the information layer of the optical disc, and the photodetector having a plurality of light-receiving surfaces for receiving the light beam reflected from the information layer of the optical disc. The optical disc device in which the optical pickup device is mounted includes at least the servo signal generation circuit for generating the focusing error signal and the tracking error signal by using the signal detected by the photodetector, the focus control circuit for exercising control to place the objective lens at a position in the focus direction with respect to the optical disc in accordance with the focusing error signal, the tracking control circuit for exercising control to place the objective lens at a desired track position with respect to the optical disc in accordance with the tracking error signal, the defocus application circuit for generating the defocus signal to be added to the focusing error signal, the tracking signal gain control circuit for generating the tracking signal gain correction amount to be given to the tracking error signal, and the control circuit for controlling the above circuits.

The control circuit exercises control as described below. Before the light beam is changed from a light intensity of 1 to a different light intensity of 2, the control circuit causes the defocus application circuit to generate a predetermined defocus signal and changes the tracking signal gain correction amount to be generated from the tracking signal gain control circuit.

After the objective lens is completely displaced to an offset position in the focus direction in accordance with the predetermined defocus signal, the light beam is changed from a light intensity of 1 to a light intensity of 2. The predetermined defocus signal generated from the defocus application circuit is terminated at substantially the same time the light beam is changed from a light intensity of 1 to a light intensity of 2.

After the objective lens is no longer offset in the focus direction, the tracking signal gain correction amount generated from the tracking signal gain control circuit is restored to its previous value.

The intensity of the defocus signal generated by the defocus application circuit is set to a value within a range within which the objective lens can perform a follow-up operation in the focus direction of the optical disc. Further, the tracking signal gain correction amount generated by the tracking signal gain control circuit is set to a value within a range within which the objective lens can perform a follow-up operation in the tracking direction of the optical disc.

### Second Embodiment

A second embodiment of the present invention will now be described. The second embodiment differs from the first embodiment in the signal waveform representing the tracking signal gain correction amount for tracking control. The configurations of the optical pickup device and optical disc device are the same as described in conjunction with the first embodiment (FIGS. 1 and 3) and will not be redundantly described.

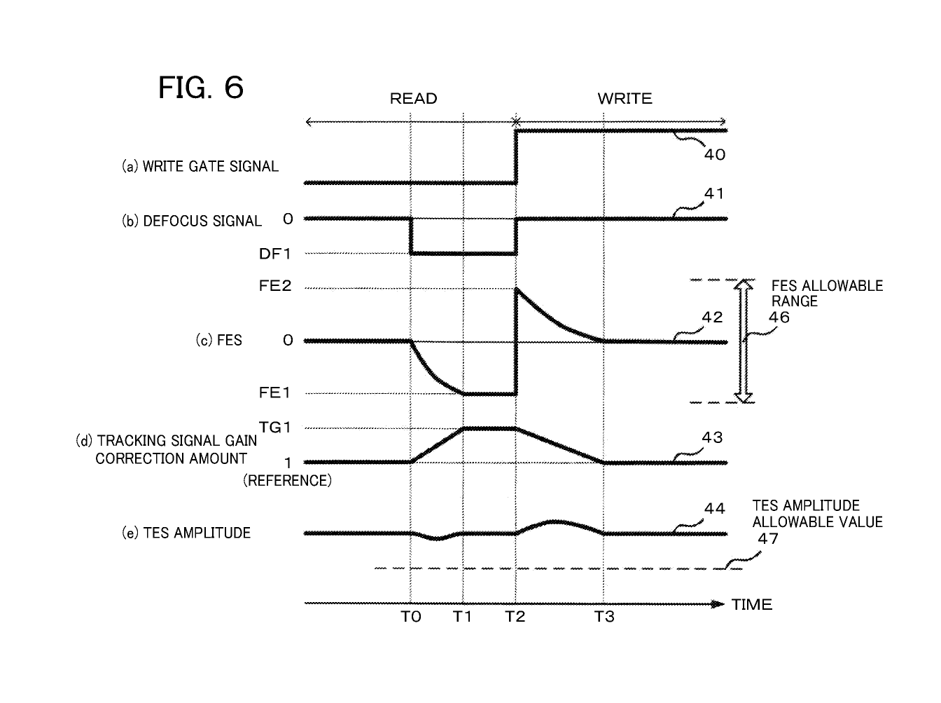

FIG. 6 is a diagram illustrating signal waveforms in the optical disc device that appear during a write operation according to the second embodiment. The signal waveforms shown in FIG. 6 are of the same type as shown in FIG. 4. Signal waveform (a) represents the write gate signal 40. Signal waveform (b) represents the defocus signal 41. Signal waveform (c) represents the focusing error signal 42. Signal waveform (d) represents the tracking signal gain correction amount 43. Signal waveform (e) represents the tracking error signal amplitude 44.

Operations performed in sequence by the present embodiment will now be described. The same operations as shown in FIG. 4 will be briefly described. In the read state prevailing before time T0, the focusing error signal (FES) 42 is 0 (zero). It means that the just-focus position is obtained. Further, the obtained amplitude 44 of the tracking error signal (TES) is equal to a predetermined value.

At time T0, which is immediately before the start of a write operation to be performed, a defocus amount DF1 optimum for the amount of color aberration is added to the focusing error signal as indicated by signal waveform (b). As a result, the focusing error signal 42 obtained from the photodetector 17 gradually becomes displaced in accordance with the added defocus amount DF1, and reaches an offset amount FE1 at time T1, as indicated by signal waveform (c).

Further, at substantially the same time the defocus amount DF1 is applied, the tracking signal gain correction amount 43 is changed as indicated by signal waveform (d). However, the tracking signal gain correction amount 43 according to the present embodiment is linearly increased with time unlike the change shown in FIG. 4. An employed gradient is such that the tracking signal gain correction amount 43 reaches TG1 at time T1 at which the focusing error signal 42 becomes displaced to the offset amount FE1. Time T1 is learned on the basis of the frequency response of the actuator 16 and stored in the data storage circuit 112 together with the tracking signal gain correction amount TG1. When the tracking signal gain correction amount 43 is changed in accordance with offset changes in the focusing error signal 42 as described above, the tracking error signal amplitude 44 prevailing during a period (T0 to T2) immediately before the start of the write operation can be substantially fixed as indicated by signal waveform (e).

When the write gate signal 40 is in the write state at time T2, the defocus signal 41 is changed from DF1 to 0 (zero) as indicated by signal waveform (b). At the same time, the tracking signal gain correction amount 43 is linearly decreased from TG1 as indicated by signal waveform (d). Then, at time T3 at which the focusing error signal 42 is at the just-focus position, the tracking signal gain correction amount 43 returns to the previous tracking signal gain correction amount (a reference value of 1) for the write operation. Time T3 is also learned on the basis of the frequency response of the actuator 16 and stored in the data storage circuit 112. At time T2, the focusing error signal 42 becomes displaced to FE2 due to the occurrence of color aberration. However, when the defocus signal 41 is changed from DF1 to 0 (zero), the offset amount gradually becomes small. When the tracking signal gain correction amount 43 is changed in accordance with offset changes in the focusing error signal 42 as described above, the tracking error signal amplitude 44 prevailing during a period (T2 to T3) immediately after the start of the write operation can also be substantially fixed as indicated by signal waveform (e).

As described above, when the tracking signal gain correction amount 43 is changed in accordance with the offset amount of the focusing error signal 42, changes in the tracking error signal amplitude 44 can be suppressed and substantially fixed. In the first embodiment, signal saturation may occur due to significant changes in the tracking error signal amplitude. In the present embodiment, however, the tracking error signal amplitude is substantially fixed as its changes are insignificant. Therefore, the present embodiment provides more stable tracking control than the first embodiment.

FIG. 6 indicates that the tracking signal gain correction amount 43 is linearly changed. Alternatively, however, changes in the offset amount of the focusing error signal may be learned to nonlinearly change the tracking signal gain correction amount 43 in accordance with the offset amount changes in the focusing error signal. Such nonlinear changes make it possible to reduce the changes in the tracking error signal amplitude 44 that occur before and after the write operation. Another alternative is to change the tracking signal gain correction amount 43 with time in a desired staircase pattern instead of linearly changing the tracking signal gain correction amount 43. Changing the tracking signal gain correction amount 43 in a desired staircase pattern permits the use of a simplified control scheme.

The present embodiment is the same as the first embodiment in the magnitudes of the defocus signal DF1 and of the tracking signal gain correction amount TG1 that are set with respect to the amount of color aberration.

The present embodiment is the same as the first embodiment in the configurations of the optical pickup device and of the optical disc device in which the optical pickup device is mounted. However, the control circuit according to the present embodiment provides a substantially constant tracking error signal amplitude by changing the tracking signal gain correction amount in accordance with the offset amount of the focusing error signal.

### Third Embodiment

A third embodiment of the present invention will now be described. When exercising tracking control, the third embodiment provides hold control of a tracking signal instead of correcting the gain of the tracking signal.

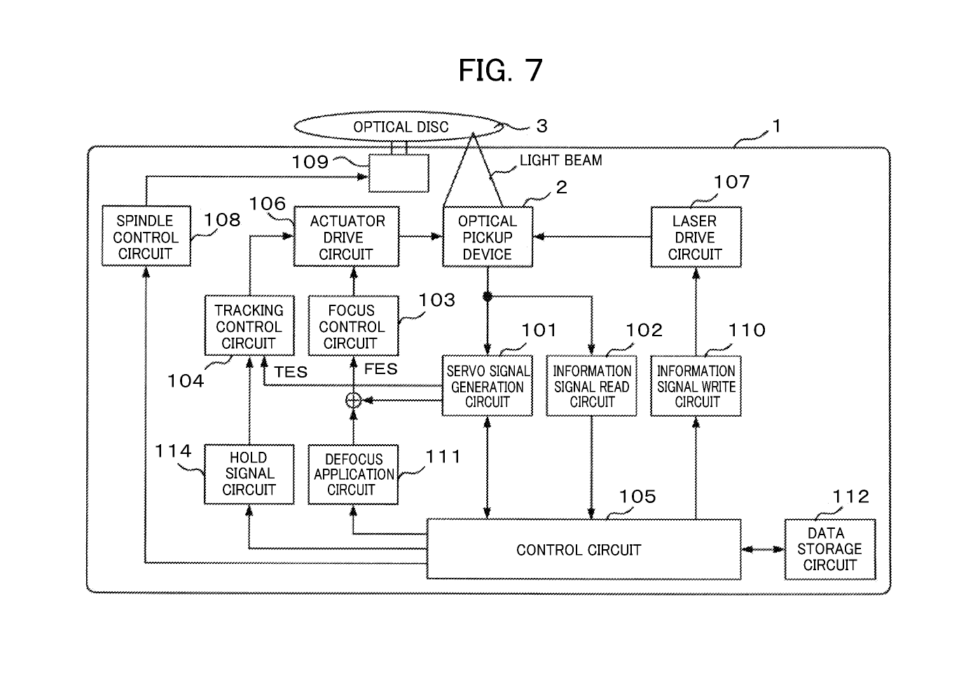

FIG. 7 is a block diagram illustrating the configuration of the optical disc device 1 according to the third embodiment. The present embodiment is characterized in that it includes a hold signal circuit 114 in place of the tracking signal gain control circuit 113 according to the first embodiment (FIG. 3). The hold signal circuit 114 is disposed between the control circuit 105 and the tracking control circuit 104. While a hold signal is ON, the hold signal circuit 114 holds the tracking error signal that is to be input from the servo signal generation circuit 101 to the tracking control circuit 104.

To correct color aberration, the control circuit 105 adds a predetermined defocus signal to the focusing error signal through the defocus application circuit 111 immediately before the start of a write operation, and inputs the addition result to the focus control circuit 103, as is the case with the first embodiment. In synchronism with the transmission of the defocus signal, the control circuit 105 causes the hold signal circuit 114 to output the hold signal that is ON, holds the tracking error signal to be input to the tracking control circuit 104 by using an immediately previous input signal, and stops tracking control that is provided by driving the actuator (causes a tracking hold). When the tracking control is stopped in the above manner, it is possible to avert the influence of tracking error signal deterioration caused by the application of the defocus signal. A period during which the hold signal is ON is controlled as predetermined by the control circuit 105.

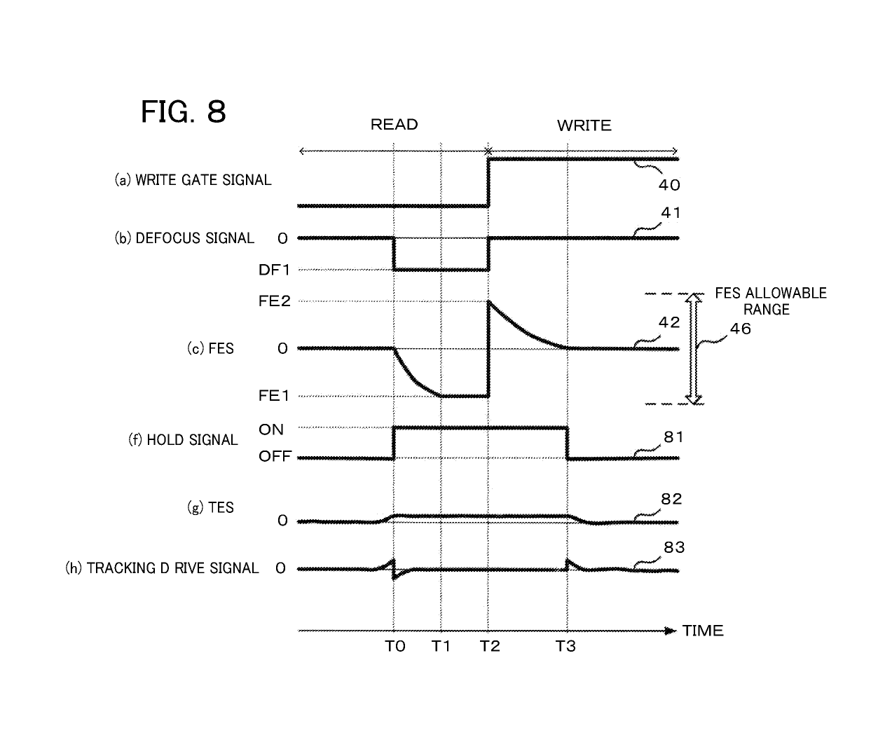

FIG. 8 is a diagram illustrating signal waveforms in the optical disc device that appear during a write operation according to the third embodiment. Signal waveform (a) represents the write gate signal 40. Signal waveform (b) represents the defocus signal 41. Signal waveform (c) represents the focusing error signal 42. These signals are the same as shown in FIG. 4. Signals newly handled in the third embodiment are described below.

Signal waveform (f) represents the hold signal 81 which is generated by the hold signal circuit 114. Tracking control is started or stopped depending on whether the hold signal 81 is ON or OFF. Signal waveform (g) represents a tracking error signal (TES) 82 that is generated by the servo signal generation circuit 101. When the tracking error signal 82 is at a 0 (zero) position, it means that the light beam is following a track center. Signal waveform (h) represents a tracking drive signal 83 that is transmitted from the tracking control circuit 104 to the actuator drive circuit 106.

Operations performed in sequence by the present embodiment will now be described. The same operations as shown in FIG. 4 will be briefly described. In the read state prevailing before time T0, the focusing error signal (FES) 42 is 0 (zero). It means that the just-focus position is obtained. As regards tracking control, the tracking error signal (TES) 82 is used, as indicated by signal waveforms (g) and (h), to supply the tracking drive signal 83 so that the light beam follows the track center of the optical disc 3.

At time T0, which is immediately before the start of a write operation to be performed, a defocus amount DF1 optimum for the amount of color aberration is added to the focusing error signal as indicated by signal waveform (b). As a result, the focusing error signal 42 obtained from the photodetector 17 gradually becomes displaced in accordance with the added defocus amount DF1, and reaches an offset amount FE1 at time T1, as indicated by signal waveform (c).

Further, at substantially the same time the defocus amount DF1 is applied, the hold signal 81 is turned ON as indicated by signal waveform (f). As the hold signal 81 input to the tracking control circuit 104 is ON, the tracking drive signal 83 is 0 (zero) as indicated by signal waveform (h). In other words, a tracking hold state occurs so that the objective lens 15 stops its follow-up operation in the tracking direction.

As described above, tracking control stops at an instant at which the hold signal 81 turns ON. This makes it possible to avert the influence of tracking error signal deterioration caused by the addition of the defocus amount. While the hold signal 81 is ON, the tracking error signal 82 indicated by signal waveform (g) is irrelevant to tracking control. Therefore, the tracking position of the objective lens 15 is determined by the tracking drive signal 83 indicated by signal waveform (h). Hence, as the tracking drive signal 83 indicated by signal waveform (h) is 0 (zero), the light beam is determined to be placed at a predetermined position within a track.

When the write gate signal 40 is in the write state at time T2, the defocus signal 41 is changed from DF1 to 0 (zero) as indicated by signal waveform (b). This gradually decreases the offset amount. The hold signal 81 continues to be ON at time T2 as indicated by signal waveform (f).

At a timing at which the focusing error signal 42 is at the just-focus position at time T3, the hold signal 81 changes from ON to OFF as indicated by signal waveform (f). Tracking control is then resumed. Tracking control is exercised by using the tracking error signal (TES) 82 as indicated by signal waveforms (g) and (h). In such an instance, the offset amount of the focusing error signal 42 is 0 (zero). Therefore, the tracking error signal 82 does not deteriorate. When tracking control is resumed, the tracking drive signal 83 is used to perform a swing protection process for the purpose of correcting the tracking direction displacement of the objective lens 15. This ensures that the light beam is pulled into the track center.

A period of time (T3 to T0) during which the hold signal 81 is ON is learned on the basis of the frequency response of the actuator and stored in the data storage circuit 112. As the holding period (T3 to T0) is as short as 500 μs or less, tracking control does not become unstable at an instant at which the hold signal changes from ON to OFF.

As described above, when the hold signal 81 turns ON at the same time the defocus signal 41 is added, tracking control stops. Therefore, the write operation can be performed without being affected by the deterioration of the tracking error signal.

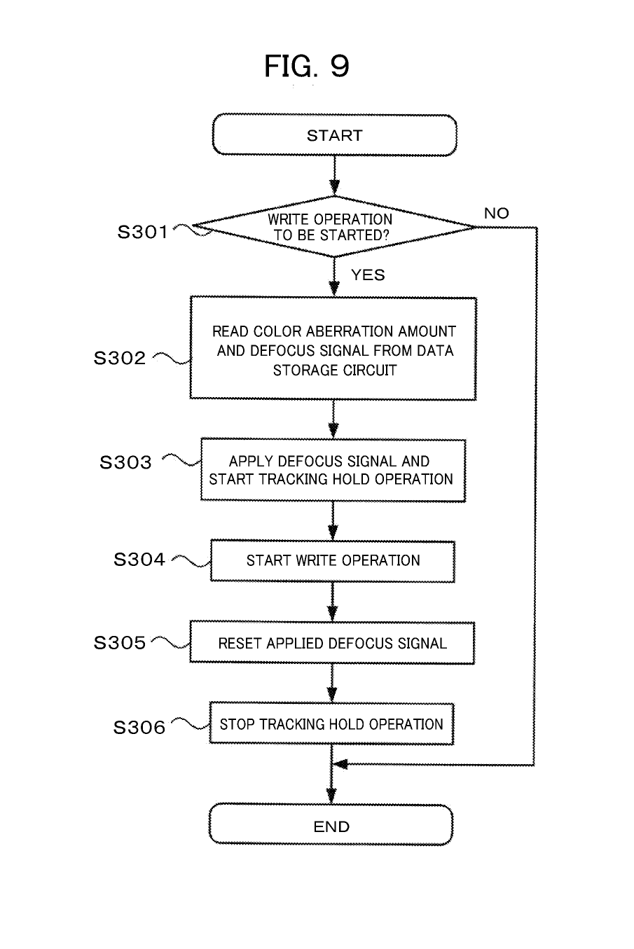

FIG. 9 is a flowchart illustrating the write operation according to the third embodiment. Individual steps of a write process will now be described in sequence. The process starts while a read operation is performed with the optical disc 3 inserted into the optical disc device 1.

Step S301 is performed to determine whether or not to start a write operation on the optical disc 3. If the query in step S301 is answered “YES”, processing proceeds to step S302. If, on the other hand, the query in step S301 is answered “NO”, the process terminates to continue with the read operation or stop the read operation. In step S302, the data storage circuit 112 is accessed to read the amount of color aberration generated by laser light emission power prevailing under current write conditions and a defocus signal (defocus amount) DF1 optimum for the amount of color aberration.

Step S303 is performed at time T0, which is immediately before the start of the write operation, to apply (add) a predetermined defocus signal DF1 to the focusing error signal through the defocus application circuit 111. At the same time, a tracking hold operation is started by turning ON the hold signal that is to be input to the tracking control circuit 104 through the hold signal circuit 114. In step S304, after the objective lens 15 is displaced to a predetermined position FE1 in accordance with the applied defocus signal DF1, the write operation starts at time T2.

In step S305, the applied defocus signal DF1 is reset at the same time the laser light emission power is increased at the beginning of the write operation. In step S306, at time T3 at which stable focus control is provided as the actuator 16 performs a follow-up operation subsequently to the reset of the defocus signal, the tracking hold operation is stopped by turning OFF the hold signal that is to be input to the tracking control circuit 104. In this instance, the time (T3 to T0) for turning OFF the hold signal after it is turned ON is read from the data storage circuit 112.

When control is exercised as described above, not only focus control but also tracking control can be provided in a stable manner in response to color aberration caused before and after the write operation.

As described above, the optical disc device according to the third embodiment includes at least the optical pickup device, the servo signal generation circuit for generating the focusing error signal and the tracking error signal by using the signal detected by the photodetector, the focus control circuit for exercising control to place the objective lens at a position in the focus direction with respect to the optical disc in accordance with the focusing error signal, the tracking control circuit for exercising control to place the objective lens at a desired track position with respect to the optical disc in accordance with the tracking error signal, the defocus application circuit for generating the defocus signal to be added to the focusing error signal, the hold signal circuit for holding the tracking error signal to be input to the tracking control circuit, and the control circuit for controlling the above circuits.

The control circuit exercises control as described below. Before the light beam is changed from a light intensity of 1 to a different light intensity of 2, the control circuit causes the defocus application circuit to generate the predetermined defocus signal and causes the hold signal circuit to generate the hold signal for the tracking control circuit.

After the objective lens is completely displaced to an offset position in the focus direction in accordance with the predetermined defocus signal, the light beam is changed from a light intensity of 1 to a light intensity of 2. The predetermined defocus signal generated from the defocus application circuit is terminated at substantially the same time the light beam is changed from a light intensity of 1 to a light intensity of 2.

After the objective lens is no longer offset in the focus direction, the hold signal generated from the hold signal circuit is terminated.

The foregoing embodiments have been described on the assumption that the optical pickup device includes a laser light source having a specific wavelength compliant with one optical disc standard. Alternatively, however, the optical pickup device may include two or more laser light sources in order to comply with a plurality of different optical disc standards. For example, when the optical pickup device includes an objective lens compliant with three different optical disc standards, such as the BD, DVD, and CD standards, an increased amount of color aberration is generated. Further, when the employed configuration is compatible with three different wavelengths, the transmittance of each wavelength decreases. This makes it necessary to increase the amount of light to be emitted from a laser light source. Hence, the amount of color aberration further increases. The present invention is particularly effective for an optical disc device having the above-described optical pickup device.

The invention is not limited to the foregoing embodiments, but extends to various modifications that nevertheless fall within the scope of the appended claims. The foregoing embodiments have been described in detail to facilitate the understanding of the present invention. The present invention is not necessarily limited to a configuration having all the above-described elements. Some of the elements included in a certain embodiment may be replaced by the elements of another embodiment. Further, the elements included in a certain embodiment may be added to the elements included in another embodiment.

What is claimed is:

1. An optical disc device that has an optical pickup device and reads information from or writes information to an optical disc, the optical pickup device including a laser light source for emitting a light beam, an objective lens for focusing the light beam on an information layer of the optical disc, and a photodetector having a plurality of light-receiving surfaces for receiving the light beam reflected from the information layer of the optical disc, the optical disc device comprising:
a servo signal generation circuit that generates a focusing error signal and a tracking error signal by using a signal detected by the photodetector;
a focus control circuit that exercises control to place the objective lens at a position in a focus direction with respect to the optical disc in accordance with the focusing error signal;
a tracking control circuit that exercises control to place the objective lens at a desired track position with respect to the optical disc in accordance with the tracking error signal;
a defocus application circuit that generates a defocus signal to be added to the focusing error signal;
a tracking signal gain control circuit that generates a tracking signal gain correction amount to be given to the tracking error signal; and
a control circuit that controls each of the above circuits;
wherein, before changing the light beam from a light intensity of 1 to a different light intensity of 2, the control circuit causes the defocus application circuit to generate a predetermined defocus signal and changes the tracking signal gain correction amount to be generated by the tracking signal gain control circuit.

2. The optical disc device according to claim 1, wherein the control circuit changes the light beam from the light intensity of 1 to the light intensity of 2 after the objective lens is completely displaced to an offset position in the focus direction in accordance with the predetermined defocus signal, terminates the predetermined defocus signal generated by the defocus application circuit at substantially the same time the light beam is changed from the light intensity of 1 to the light intensity of 2, and restores the tracking signal gain correction amount generated by the tracking signal gain control circuit to a previous value thereof after the objective lens is no longer offset in the focus direction.

3. The optical disc device according to claim 1, wherein the control circuit sets the intensity of the defocus signal generated by the defocus application circuit to a value within a range within which the objective lens can perform a follow-up operation in the focus direction of the optical disc, and sets the tracking signal gain correction amount generated by the tracking signal gain control circuit to a value within a range within which the objective lens can perform a follow-up operation in a tracking direction of the optical disc.

4. The optical disc device according to claim 2, wherein the control circuit changes the tracking signal gain correction amount generated by the tracking signal gain control circuit in accordance with an offset amount of the focusing error signal.

5. An optical disc device that has an optical pickup device and reads information from or writes information to an optical disc, the optical pickup device including a laser light source for emitting a light beam, an objective lens for focusing the light beam on an information layer of the optical disc, and a photodetector having a plurality of light-receiving surfaces for receiving the light beam reflected from the information layer of the optical disc, the optical disc device comprising:
a servo signal generation circuit that generates a focusing error signal and a tracking error signal by using a signal detected by the photodetector;
a focus control circuit that exercises control to place the objective lens at a position in a focus direction with respect to the optical disc in accordance with the focusing error signal;
a tracking control circuit that exercises control to place the objective lens at a desired track position with respect to the optical disc in accordance with the tracking error signal;
a defocus application circuit that generates a defocus signal to be added to the focusing error signal;
a hold signal circuit that holds the tracking error signal to be input to the tracking control circuit; and
a control circuit that controls each of the above circuits;
wherein, before changing the light beam from a light intensity of 1 to a different light intensity of 2, the control circuit causes the defocus application circuit to generate a predetermined defocus signal and causes the hold signal circuit to generate a hold signal for the tracking control circuit.

6. The optical disc device according to claim 5, wherein the control circuit changes the light beam from the light intensity of 1 to the light intensity of 2 after the objective lens is completely displaced to an offset position in the focus direction in accordance with the predetermined defocus signal, terminates the predetermined defocus signal generated from the defocus application circuit at substantially the same time the light beam is changed from the light intensity of 1 to the light intensity of 2, and terminates the hold signal generated by the hold signal circuit after the objective lens is no longer offset in the focus direction.

7. The optical disc device according to claim 1, wherein one of the light intensity of 1 and the light intensity of 2 of the light beam is a light intensity for writing information to the optical disc, and the other is a light intensity for reading information from the optical disc.
